(19) United States
(12) Patent Application Publication
(10) Pub. No.: US 2025/0378355 A1
(43) Pub. Date: Dec. 11, 2025

(54) SYSTEMS AND METHODS FOR RETRIEVING INFORMATION FROM KNOWLEDGE GRAPHS BASED ON QUERY CONTEXT

(71) Applicant: Optum, Inc., Minnetonka, MN (US)

(72) Inventors: Carlos W Morato, Sammamish, WA (US); Sanjay Kumar Singh, Bengaluru (IN); Shibsankar Das, Begampur (IN); Udit Saini, Bhupatwala Haridwar (IN); Kevin Obrien, Staten Island, NY (US); Devdatta R Halbe, Eden Prairie, MN (US); Zahra Rajabi, Vienna Fairfax, VA (US); Ravi Pande, Gautam Budh Nagar (IN); Hitesh Mehra, Bangalore (IN); Ashwini Kumar, Bangalore (IN)

(21) Appl. No.: 18/736,786

(22) Filed: Jun. 7, 2024

(51) Int. Cl. G06N 5/04; G06N 5/02

(52) U.S. Cl. CPC G06N 5/04; G06N 5/02

(57) ABSTRACT

Various embodiments of the present disclosure provide methods, apparatus, systems, computing devices, computing entities, and/or the like for retrieving a subgraph that is used to generate one or more answer outputs responsive to an input query by: (i) generating one or more context embeddings that are associated with an input query, (ii) identifying one or more candidate node paths and one or more node relations based on a knowledge graph, (iii) identifying, using a predictive machine learning model, one or more context-relationship rankings based on the one or more candidate node paths, the one or more node relations, and the one or more context embeddings, and (iv) generating one or more subgraph data objects based on the one or more context-relationship rankings.

### CROSS REFERENCE TO RELATED APPLICATION

This application is related to U.S. patent application Ser. No. 18/591,292, entitled “GENERATING LARGE LANGUAGE MODEL PROMPTS BASED ON KNOWLEDGE GRAPHS,” filed on Feb. 29, 2024, the disclosure of which is hereby incorporated by reference in its entirety.

### BACKGROUND

An organized collection of data may be stored in a knowledge base via one or more knowledge graphs. Knowledge graphs may be accessed by an information retrieval system to retrieve information from the knowledge base in response to a query or question. A knowledge graph may comprise information that are associated with different topics, mentions (e.g., entities), and documents to support conversations and search involving various retrieval tasks, such as searching answers by relationship of nodes (e.g., entities, topics, or documents) in the knowledge graph. For example, a knowledge graph-based search may comprise targeting to answer “what” (e.g., what are possible connecting documents (discovered via nodes/edges) that are related to a query).

However, a knowledge graph may comprise a large amount of data that may cause difficulties in retrieving relevant data. In particular, the amount of data contained in a knowledge graph may make it difficult to draw conclusions from the data. For example, a knowledge graph may comprise many branch nodes that are not relevant to a query or many non-adjacent node paths. As such, despite a knowledge graph comprising all the information and contexts that are relevant to a query, an information retrieval system may have difficulties in identifying key nodes that may lead to the most relevant data to answer to respond to a query.

Various embodiments of the present disclosure address technical challenges related to information retrieval and provide solutions to address shortcomings of existing search solutions.

### BRIEF SUMMARY

In general, various embodiments of the present disclosure provide methods, apparatus, systems, computing devices, computing entities, and/or the like for improving knowledge graph-based information retrieval based on context-relationship predictions.

Various embodiments of the present disclosure make important technical contributions to contextual text analysis by generating context-relationship ranking predictions based on the candidate node paths within a graph data structure, as well as, node relationships and context embeddings associated with each of the candidate node paths. As described herein, knowledge graph data objects comprising vast amounts of information may render searching for specific information from the knowledge graph data objects difficult. To address technical challenges with graph-based information retrieval, the present disclosure presents techniques for extracting information associated with relationships and rankings of a plurality of topics, entities, and documents from query inputs. In this way, some of the techniques of the present disclosure improve accuracy of performing predictive operations, as needed, on data having topic-entity-document dependencies.

In some embodiments, a computer-implemented method comprises generating, by one or more processors, one or more context embeddings based on a contextual representation data object that is associated with a query input; identifying, by the one or more processors, one or more candidate node paths and one or more node relations that are associated with one or more knowledge graph data objects; generating, by the one or more processors and using a predictive machine learning model, one or more context-relationship ranking predictions based on the one or more candidate node paths, the one or more node relations, and the one or more context embeddings; generating, by the one or more processors, one or more subgraph data objects from the one or more knowledge graph data objects based on the one or more context-relationship ranking predictions; and generating, by the one or more processors, one or more answer outputs for the query input based on the one or more subgraph data objects.

In some embodiments, a computing system comprises memory and one or more processors communicatively coupled to the memory, the one or more processors configured to generate one or more context embeddings based on a contextual representation data object that is associated with a query input; identify one or more candidate node paths and one or more node relations that are associated with one or more knowledge graph data objects; generate, using a predictive machine learning model, one or more context-relationship ranking predictions based on the one or more candidate node paths, the one or more node relations, and the one or more context embeddings; generate one or more subgraph data objects from the one or more knowledge graph data objects based on the one or more context-relationship ranking predictions; and generate one or more answer outputs for the query input based on the one or more subgraph data objects.

In some embodiments, one or more non-transitory computer-readable storage media includes instructions that, when executed by one or more processors, cause the one or more processors to generate one or more context embeddings based on a contextual representation data object that is associated with a query input; identify one or more candidate node paths and one or more node relations that are associated with one or more knowledge graph data objects; generate, using a predictive machine learning model, one or more context-relationship ranking predictions based on the one or more candidate node paths, the one or more node relations, and the one or more context embeddings; generate one or more subgraph data objects from the one or more knowledge graph data objects based on the one or more context-relationship ranking predictions; and generate one or more answer outputs for the query input based on the one or more subgraph data objects.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is a flowchart diagram of an example process for retrieving context relevant information in accordance with some embodiments of the present disclosure.

FIG. 5 depicts an operational example of a subgraph data object in accordance with some embodiments of the present disclosure.

FIG. 6 depicts an operational example of an information retrieval system in accordance with some embodiments of the present disclosure.

FIG. 7 depicts an example architecture of a predictive information retrieval framework in accordance with some embodiments of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

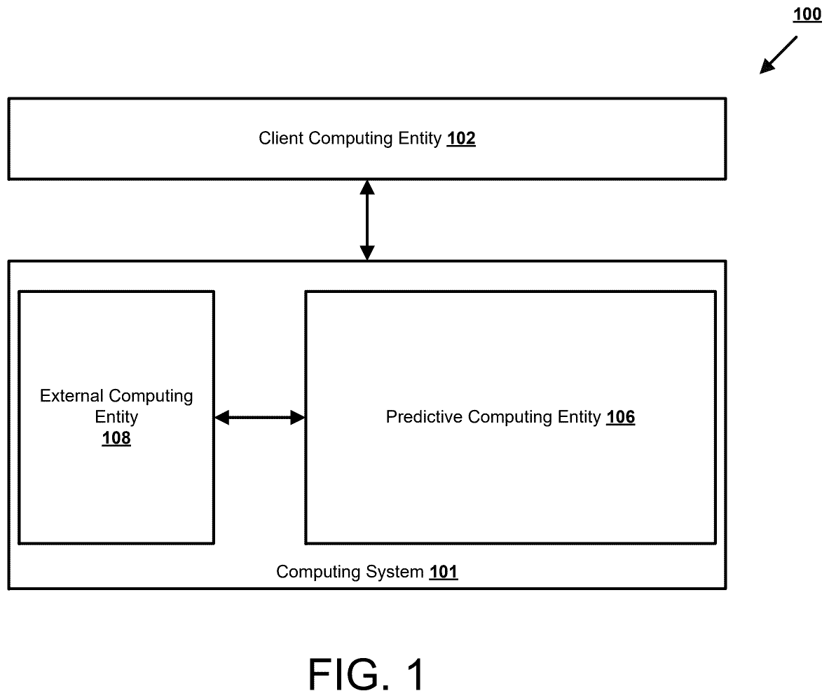

FIG. 1 provides an example overview of an architecture 100 in accordance with some embodiments of the present disclosure. The architecture 100 includes a computing system 101 configured to receive predictive data analysis/query requests from one or more client computing entity 102, process the predictive data analysis/query requests to generate predictions and/or retrieve answer outputs based on the generated predictions, and provide the generated predictions and/or answer outputs to the one or more client computing entity 102. The example architecture 100 may be used in a plurality of domains and not limited to any specific application as disclosed herewith. The plurality of domains may include banking, healthcare, industrial, manufacturing, education, retail, to name a few.

In accordance with various embodiments of the present disclosure, a predictive machine learning model is trained to generate one or more context-relationship ranking predictions for generating one or more subgraph data objects. The one or more subgraph data objects may comprise information that is retrieved from one or more knowledge graph data objects by identifying portions (e.g., node paths) of the one or more knowledge graph data objects that are contextually relevant to a query input. As such, one or more answer outputs may be generated for the query input based on the one or more subgraph data objects. This technique will lead to higher accuracy of performing predictive operations as needed for retrieving information and/or generating responses (e.g., answers) that are contextually relevant to search queries (e.g., questions) based on topic-entity-document dependencies. In doing so, the techniques described herein improve retrieval criteria for a subject of a search query and an amount of relevant results may be increased, thus improving the accuracy and performance of information retrieval systems.

In some embodiments, the computing system 101 may communicate with at least one of the one or more client computing entity 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive data analysis computing entity 106 and one or more external computing entities 108. The predictive data analysis computing entity 106 and/or one or more external computing entities 108 may be individually and/or collectively configured to receive predictive data analysis/query requests from one or more client computing entity 102, process the predictive data analysis/query requests to generate predictions and/or retrieve answer outputs based on the generated predictions, and provide the generated predictions and/or answer outputs to the one or more client computing entity 102.

For example, as discussed in further detail herein, the predictive data analysis computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the predictive data analysis computing entity 106 and/or one or more external computing entities 108 are communicatively coupled using one or more wired and/or wireless communication techniques. The respective computing entities may be specially configured to perform one or more steps/operations of one or more techniques described herein. By way of example, the predictive data analysis computing entity 106 may be configured to train, implement, use, update, and evaluate machine learning models in accordance with one or more training and/or prediction operations of the present disclosure. In some examples, the external computing entities 108 may be configured to train, implement, use, update, and evaluate machine learning models in accordance with one or more training and/or prediction operations of the present disclosure.

In some example embodiments, the predictive data analysis computing entity 106 may be configured to receive and/or transmit one or more datasets, objects, and/or the like from and/or to the external computing entities 108 to perform one or more steps/operations of one or more techniques (e.g., data synthesis techniques, labeling techniques, ranking techniques, classification techniques, and/or the like) described herein. The external computing entities 108, for example, may include and/or be associated with one or more entities that may be configured to receive, transmit, store, manage, and/or facilitate datasets, such as a dataset including a plurality of heterogeneous documents, and/or the like. The external computing entities 108, for example, may include data sources that may provide such datasets, and/or the like to the predictive data analysis computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive data analysis computing entity 106 to obtain and aggregate data for a prediction domain.

In some example embodiments, the predictive data analysis computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive data analysis computing entity 106, which may leverage the trained machine learning model to perform one or more prediction steps/operations of the present disclosure. In some examples, feedback (e.g., evaluation data, ground truth data, etc.) from the use the of the machine learning model may be recorded by the predictive data analysis computing entity 106. In some examples, the feedback may be provided to the one or more external computing entities 108 to continuously train the machine learning model over time. In some examples, the feedback may be leveraged by the predictive data analysis computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Data Analysis Computing Entity

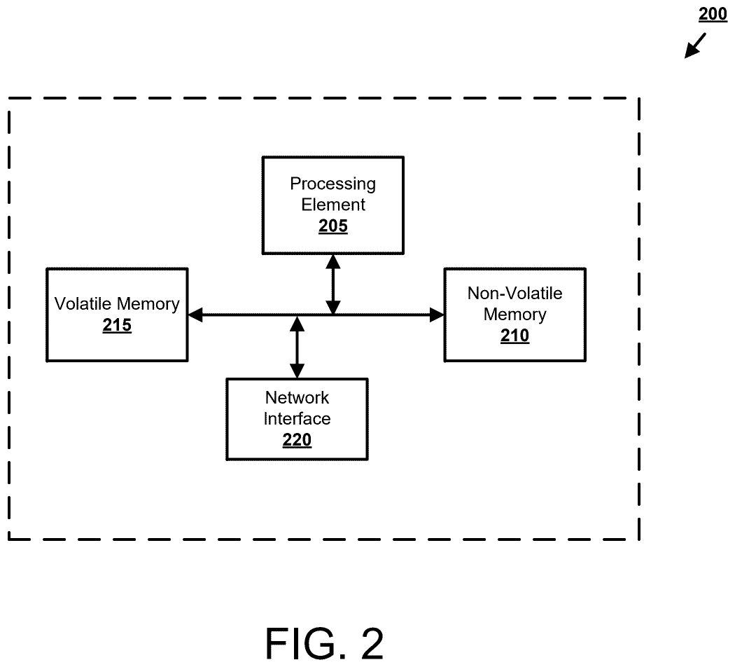

FIG. 2 provides an example computing entity 200 in accordance with some embodiments of the present disclosure. The computing entity 200 is an example of the predictive data analysis computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive data analysis computing entity 106, etc.) may train and use one or more machine learning models described herein. In other embodiments, a first computing entity (e.g., predictive data analysis computing entity 106, etc.) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized parameters, weights, code sets, etc.) to the first computing entity over a network.

As shown in FIG. 2, in some embodiments, the predictive data analysis computing entity 106 may include, or be in communication with, one or more processing elements 205 (also referred to as processor(s), processing circuitry, and/or similar terms used herein interchangeably) that communicate with other elements within the predictive data analysis computing entity 106 via a bus, for example. As will be understood, the processing elements 205 may be embodied in a number of different ways.

For example, the processing elements 205 may be embodied as one or more complex programmable logic devices (CPLDs), microprocessors, multi-core processors, coprocessing entities, application-specific instruction-set processors (ASIPs), microcontrollers, and/or controllers. Further, the processing elements 205 may be embodied as one or more other processing devices or circuitry. The term circuitry may refer to an entirely hardware embodiment or a combination of hardware and computer program products. Thus, the processing elements 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing elements 205 may be configured for a particular use or configured to execute instructions stored in volatile or non-volatile media or otherwise accessible to the processing elements 205. As such, whether configured by hardware or computer program products, or by a combination thereof, the processing elements 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like being executed by, for example, the processing elements 205. Thus, the databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like may be used to control certain aspects of the operation of the computing entity 200 with the assistance of the processing elements 205 and operating system.

As indicated, in some embodiments, the computing entity 200 may also include one or more network interfaces 220 for communicating with various computing entities (e.g., the one or more client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example Client Computing Entity

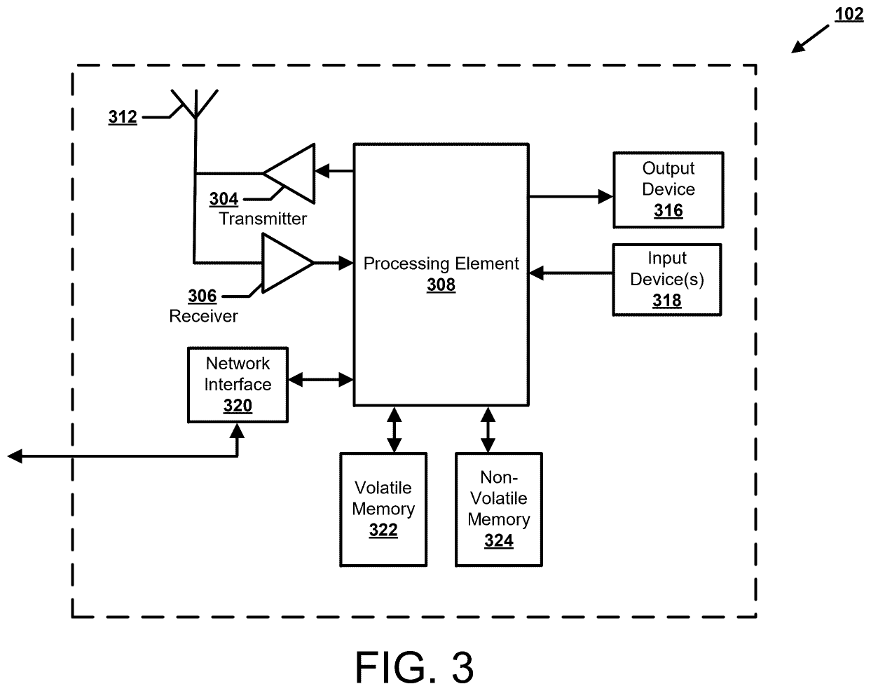

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entity 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. EXAMPLES OF CERTAIN TERMS

In some embodiments, the term “topic” refers to a data construct that describes a subject matter or description that is representative of content associated with at least a portion of a document. According to various embodiments of the present disclosure, the contents of a document may be characterized by one or more topics. For example, a document may comprise one or more content portions and the one or more content portions may be associated with one or more topics. In some embodiments, a plurality of topics within a document may or may not be related. In some embodiments, one or more topics may be associated with one or more entities. In some embodiments, a topic is ranked based on a topic randomness score.

In some embodiments, the term “entity” refers to a data construct that describes a subject of a topic, such as an object (either real-world or virtual (e.g., data object or file)), location, article, person, program, service, task, operation, computing entity, and/or the like unit. According to various embodiments of the present disclosure, one or more entities are associated with one or more documents based on one or more document-topic-entity relationship features.

In some embodiments, the term “document” refers to a data construct that describes an electronic file comprising content or information. A document may be stored in a database and indexed for retrieval, e.g., by a search engine. For example, a document may comprise content that matches a query input. The content of a document may comprise one or more segments that are associated with one or more topics, and the one or more topics may be associated with one or more entities. According to various embodiments of the present disclosure, a document may be ranked with respect to one or more topics and one or more entities based on one or more document-topic-entity relationship features.

In some embodiments, the term “document-topic-entity relationship feature” refers to a data construct that describes a relationship between one or more documents, one or more topics, or one or more entities. According to various embodiments of the present disclosure, one or more document-topic-entity relationship features associated with a plurality of topics, a plurality of entities, and a plurality of documents are generated.

In some embodiments, the term “category” refers to a data construct that describes a class to which an entity or topic may be assigned or associated with. A category may be used to describe a commonality among entities or topics within the category. For example, entities or topics may be assigned to or associated with specific categories based on data features of the entities or topics. That is, a category may be used to identify entities or topics comprising one or more shared data features.

In some embodiments, the term “intent” refers to a data construct that describes a purpose or objective. For example, an intent of a query input may be identified and used to determine what a user that provided the query input wants to retrieve (e.g., one or more documents) or receive (e.g., an answer) in response to the query input.

In some embodiments, the term “enriched utterance” refers to a data construct that describes one or more words, phrases, or string of text that comprise one or more enhancements to original one or more words, phrases, or string of text, such as a query input. An enriched utterance may be generated to improve a query input with respect to increasing relevancy, precision, or matching accuracy, e.g., via an information retrieval system, to a corpus of documents. In some embodiments, generating an enriched utterance comprises determining one or more of synonyms, spelling-corrections, or similar concepts with respect to a query input.

In some embodiments, the term “contextual representation data object” refers to a data construct that describes a context window comprising a range of contexts for a word or phrase, such as a query input. According to various embodiments of the present disclosure, a contextual representation data object of a query input comprises data that is representative of one or more entities, one or more topics, one or more categories, one or more intents, and one or more enriched utterances. For example, a contextual representation data object for a query input may comprise insights, such as entities (e.g., procedure: MRI, problem: head pain, dependent: wife), topics (e.g., “physician services”), categories (e.g., “preventative care”), and/or intent (e.g., “benefits”).

In some embodiments, the term “context” refers to a data construct that describes one or more features that are representative of a word or phrase, such as a query input.

In some embodiments, the term “context embedding” refers to a data construct that describes a latent representation of a contextual representation data object. For example, a context embedding may be expressed as one or more vectors comprising one or more numbers representative of one or more data features or variables associated with a contextual representation data object. In some embodiments, a context embedding may be generated by mapping one or more data features of a contextual representation data object to one or more elements in a feature vector space. According to various embodiments of the present disclosure, one or more context embeddings are generated based on a contextual representation data object that is associated with a query input. In some embodiments, generating one or more context embeddings comprises determining a plurality of positive constraints for a plurality of entities based on a cost function that is associated with a maximum distance measurement of the plurality of entities and a plurality of retrofitted entities. In some embodiments, generating one or more context embeddings comprises determining a plurality of negative constraints for a plurality of entities based on a cost function that is associated with a minimum distance measurement of the plurality of entities and a plurality of retrofitted entities. In some embodiments, generating one or more context embeddings comprises determining a plurality of similar contexts for a plurality of entities or topics based on one or more feature similarities.

In some embodiments, the term “feature similarity” refers to a data construct that describes a degree of likeness between a pair of features that are associated with a respective pair of entities or topics. In some embodiments, determining one or more feature similarities comprises (i) generating one or more retrofitted entities from a first portion of a plurality of entities or topics based on one or more inclusion features and (ii) generating one or more counter-fitted entities from a second portion of the plurality of entities or topics based on one or more exclusion features. In some embodiments, determining one or more feature similarities comprises (i) determining one or more hop relations based on a plurality of shared documents (e.g., entities or topics that appear in one or more of the same documents), (ii) associating a query input with one or more documents, one or more entities, or one or more topics based on the one or more hop relations, and (iii) generating one or more retrofitted entities or one or more counter-fitted entities based on the associations.

In some embodiments, the term “query input” refers to a data construct that describes a request for information. For example, a query input may comprise one or more words, terms, or a string of characters, numbers, symbols, or any combination thereof, that may be entered by a user and received by a data analysis system from one or more client computing entities, either directly or indirectly via, e.g., an information retrieval system comprising a search engine. A query input may be used by an information retrieval system to match the query input with a corpus of content items or data objects for retrieval.

In some embodiments, the term “node path” refers to a data construct that describes a set of nodes that are connected by edges therebetween. According to various embodiments of the present disclosure, a node path is generated by traversing one or more neighboring nodes connected by one or more edges based on one or more node relations. In some embodiments, a node path is generated based on at least a portion of a knowledge graph data object. According to various embodiments of the present disclosure, one or more node paths are identified from one or more knowledge graph data objects. In some embodiments, a node path comprises a set of connected entity, topic, or documents nodes.

In some embodiments, the term “node relation” refers to a data construct that describes a relationship of nodes (e.g., representative of entities, topics, or documents) in a graph, such as a knowledge graph data object. For example, a node relation between a pair of entities, topics, or documents may be determined based on (i) whether two nodes are connected by one or more edges and (ii) a number of edges or hops between the two nodes. According to various embodiments of the present disclosure, one or more node relations are identified from (e.g., edges of) one or more knowledge graph data objects. In some embodiments, identifying one or more node relations comprises generating, using a variational autoencoder machine learning model, an output sequence of node relations based on an input sequence that comprises data from a knowledge graph data object, such as a candidate node path including one or more candidate entities, one or more candidate topics, and/or one or more candidate node relations. A variational autoencoder machine learning model may provide capability for adapting to knowledge graph data objects that comprise evolving data or data that is not well defined (e.g., adapting edges and nodes that have not been seen/inducted before).

In some embodiments, the term “knowledge graph data object” refers to a data construct that describes a network of one or more data elements and one or more relationships between the one or more data elements. In some embodiments, the one or more data elements comprise nodes that are representative of topics, entities, or documents. According to various embodiments of the present disclosure, a knowledge graph data object comprises a representation of interrelationships between topics, entities, and documents. In some embodiments, a knowledge graph data object comprises (i) a plurality of nodes associated with one or more topics, one or more entities, or one or more documents and (ii) a plurality of edges between the plurality of nodes. In some embodiments, a knowledge graph data object is generated based on one or more document-topic-entity relationship features. In some embodiments, one or more answer outputs are generated based on one or more knowledge graph data objects (e.g., via one or more subgraph data objects).

In some embodiments, the term “context-relationship ranking prediction” refers to a data construct that describes a relevancy of a node path for a context (e.g., that is associated with a query input). A context-relationship ranking prediction may comprise a probability or score that is associated with a match or degree of similarity between a node path and a query input. In some embodiments, a context-relationship ranking prediction is used to assign a weight (e.g., positive (contextual path) or negative (non-contextual path)) to a node path (e.g., based on one or more knowledge graph data objects), which may be used to generate a subgraph data object. According to various embodiments of the present disclosure, a context-relationship ranking prediction is generated based on (i) a candidate node path (e.g., from a plurality of node paths of a knowledge graph data object), (ii) one or more node relations associated with the candidate node path, and (iii) one or more context embeddings that are associated with a query input. In some embodiments, generating a context-relationship ranking prediction comprises (i) determining one or more context rankings that are associated with one or more context embeddings of a query input and (ii) determining one or more relationship rankings that are associated with one or more candidate node paths and one or more node relations of one or more knowledge graph data objects. In some embodiments, a context-relationship ranking prediction comprises an output generated by a predictive machine learning model. According to various embodiments of the present disclosure, a subgraph data object is generated from one or more knowledge graph data objects (e.g., via one or more node paths and one or more node relations) based on one or more context-relationship ranking predictions.

In some embodiments, the term “subgraph data object” refers to a data construct that describes a network of one or more data elements (e.g., nodes and edges associated with topics, entities, or documents) and one or more relationships between the one or more data elements. According to various embodiments of the present disclosure, one or more subgraph data objects are generated from one or more knowledge graph data objects (e.g., via one or more node paths and one or more node relations) based on one or more context-relationship ranking predictions. That is, a subgraph data object may be representative of specific data (e.g., node paths and node relations) identified and/or extracted from one or more knowledge graph data objects. In some embodiments, a subgraph data object (e.g., for generating answer outputs) is generated by determining one or more documents and/or entities that are high ranking with respect to a query input based on one or more knowledge graph data objects and/or a knowledge base comprising one or more document-topic-entity relationship features and rankings associated with the one or more documents and/or entities. In some embodiments, one or more answer outputs are generated for a query input based on one or more subgraph data objects.

In some embodiments, the term “answer output” refers to a data construct that describes a response to a query input. For example, an answer output may comprise any one of information, predictions, or content items (e.g., provided as search results). According to various embodiments of the present disclosure, one or more answer outputs are generated based on one or more subgraph data objects. In some embodiments, generating the one or more answer outputs comprises traversing the one or more subgraph data objects and identifying one or more entities and/or one or more documents from the one or more subgraph data objects that are relevant to a query input based on the traversal of the one or more subgraph data objects.

In some embodiments, the term “similarity score” refers to a data construct that describes a measure of how alike data objects are to each other. For example, a similarity score may be generated by comparing one or more first values of a first data construct with one or more first values of a second data construct. In some embodiments, a similarity score is determined based on a distance function. A distance function may comprise a mathematical formula that may be used to calculate a distance between features of two data objects. Examples of distance functions include, but are not limited to, Euclidean distance, Manhattan distance, Minkowski distance, Jaccard distance, Cosine similarity, and any other types of distance measurements apparent to one of ordinary skill in the art.

In some embodiments, the term “predictive machine learning model” refers to a data construct that describes parameters, hyperparameters, and/or defined operations of a machine learning model that is configured to generate one or more context-relationship ranking predictions based on one or more candidate node paths, one or more node relations, and one or more context embeddings. In some embodiments, a predictive machine learning model comprises a supervised machine learning model. In some embodiments, a predictive machine learning model is configured to generate one or more context-relationship ranking predictions by (i) comparing one or more knowledge graph embeddings that are associated with one or more nodes of one or more candidate node paths with one or more context embeddings that are associated with a query input and (ii) determining similarity between the one or more nodes and the one or more context embeddings based on the comparison. In some embodiments, a predictive machine learning model is trained by generating one or more parameters based on training data that comprises a plurality of training queries, a plurality of training node paths, a plurality of training node relations, and a plurality of contextual path labels. In some embodiments, one or more training node paths (e.g., used as training data for training a predictive machine learning model) are labeled based on respective one or more classification outputs that are generated by a node path classifier machine learning model. In some embodiments, a node path classifier machine learning model (i) generates predicted node path scores, (ii) compares the predicted node path scores with actual node path scores, and (iii) learns to minimize a difference between the predicted node path score and the actual node path scores. In some embodiments, a predictive machine learning model is fine-tuned by (i) generating one or more validation context-relationship ranking predictions for one or more validation node paths based on one or more trained parameters, (ii) generating one or more similarity scores by comparing the one or more validation context-relationship ranking predictions with respective one or more actual rankings for the one or more validation node paths, and (iii) fine-tuning the predictive machine learning model by generating one or more updated parameters based on the one or more similarity scores.

In some embodiments, the term “variational autoencoder machine learning model” refers to a data construct that describes parameters, hyperparameters, and/or defined operations of a machine learning model that is configured to generate a predictive output by reconstructing an input that is provided to the variational autoencoder machine learning model. According to various embodiments of the present disclosure, a variational autoencoder machine learning model is configured (or used) to generate an output sequence of node relations based on an input sequence that comprises data from a knowledge graph data object, such as a candidate node path including one or more candidate entities, one or more candidate topics, and one or more candidate node relations.

In some embodiments, the term “node path classifier machine learning model” refers to a data construct that describes parameters, hyperparameters, and/or defined operations of a machine learning model that is configured to label one or more training node paths by generating weights for node paths within one or more knowledge graph data objects thereby creating labeled contextual paths as training node paths. In some embodiments, a node path classifier machine learning model comprises a binary classifier machine learning model. In some embodiments, a plurality of node paths contributes to a labeled contextual path in a manner where node path weights are agnostic to path length (despite a longer path may indeed be most relevant path for a context). In some embodiments, a node path classifier machine learning model is trained on node paths that are labeled as either positive contextual paths or negative non-contextual paths.

### IV. OVERVIEW

Various embodiments of the present disclosure make important technical contributions to contextual text analysis that address the efficiency and reliability shortcomings of existing information retrieval systems. For example, some techniques of the present disclosure improve the predictive accuracy of predictive machine learning models used in generating responses to search queries. To do so, the predictive machine learning models may be trained to generate context-relationship ranking predictions based on candidate node paths, node relations, and context embeddings. As such, information associated with relationships and rankings of a plurality of topics, entities, and documents may be extracted from query inputs and leveraged to generate answer outputs that are targeted based on contexts and dependencies. By doing so, some of the techniques of the present disclosure improve the training speed and training efficiency of training predictive machine learning models while improving the predictive performance of the resulting models.

It is well-understood in the relevant art that there is typically a tradeoff between predictive accuracy and training speed, such that it is trivial to improve training speed by reducing predictive accuracy. Thus, the challenge is to improve training speed without sacrificing predictive accuracy through innovative machine learning model architectures. Accordingly, some of the techniques of the present disclosure that improve predictive accuracy without harming training speed, such as the techniques described herein, enable improving training speed given an improved predictive accuracy. In doing so, some of the techniques described herein improve efficiency and speed of training predictive machine learning models, thus reducing the number of computational operations needed and/or the amount of training data entries needed to train predictive machine learning models. Accordingly, some of the techniques described herein improve the computational efficiency, storage-wise efficiency, and/or speed of training machine learning models, while improving the model's predictive performance.

Various embodiments of the present disclosure improve information retrieval performance by generating one or more context-relationship ranking predictions based on candidate node paths, node relations, and context embeddings. As described herein, knowledge graph data objects comprising vast amounts of information may render searching for specific information from the knowledge graph data objects difficult. For example, knowledge graph data objects may comprise many branch nodes that are not relevant to given query inputs or many non-adjacent node paths that result in cumbersome (e.g., computationally inefficient) search operations.

In accordance with various embodiments of the present disclosure, a predictive machine learning model is trained to generate one or more context-relationship ranking predictions for generating one or more subgraph data objects. The one or more subgraph data objects may comprise information that is retrieved from one or more knowledge graph data objects by identifying portions (e.g., node paths) of the one or more knowledge graph data objects that are contextually relevant to a query input. As such, one or more answer outputs may be generated for the query input based on the one or more subgraph data objects. This technique will lead to higher accuracy of performing predictive operations as needed for retrieving information and/or generating responses (e.g., answers) that are contextually relevant to search queries (e.g., questions) based on topic-entity-document dependencies. In this manner, some of the techniques of the present disclosure, improve retrieval criteria for a subject of a search query and the relevancy of search results may be increased, thus improving the accuracy and performance of information retrieval systems.

In accordance with various embodiments of the present disclosure, one or more context-relationship ranking predictions may be generated for one or more candidate nodes from one or more knowledge graph data objects to rank to the one or more candidate nodes based on query input context. By doing so, information that is contextually relevant to query inputs may be intelligently selected from one or more knowledge graph data objects and used to generate answer outputs for one or more query inputs. In this way, some of the techniques of the present disclosure may be practically applied to improve answer outputs, such as search results or answers to questions, relative to traditional search engines.

Moreover, some of the techniques (e.g., the embedding techniques, ranking techniques, etc.) of the present disclosure may be applied to improve efficiency and speed of training predictive machine learning models. This, in turn, reduces the number of computational operations needed and/or the amount of training data entries needed to train predictive machine learning models. Accordingly, the techniques described herein improve the computational efficiency, storage-wise efficiency, and/or speed of training predictive machine learning models. Other technical improvements and advantages may be realized by one of ordinary skill in the art.

Examples of technologically advantageous embodiments of the present disclosure include: (i) subgraph data object generation techniques that leverage context embeddings to identify contextually relevant portions of knowledge graph data objects, (ii) candidate node path ranking for generating improved answer outputs, and (iii) machine learning training techniques for improving model accuracy while reducing computational resource usage, among others. Other technical improvements and advantages may be realized by one of ordinary skill in the art.

### V. EXAMPLE SYSTEM OPERATIONS

As indicated, various embodiments of the present disclosure make important technical contributions to contextual text analysis that address the efficiency and reliability shortcomings of existing information retrieval systems by generating one or more context-relationship ranking predictions based on one or more candidate node paths, one or more node relations, and one or more context embeddings. By doing so, information that is contextually relevant to query inputs may be intelligently selected from one or more knowledge graph data objects and used to generate answer outputs for one or more query inputs. In this way, some of the techniques of the present disclosure may be practically applied to improve answer outputs, such as search results or answers to questions, relative to traditional search engines.

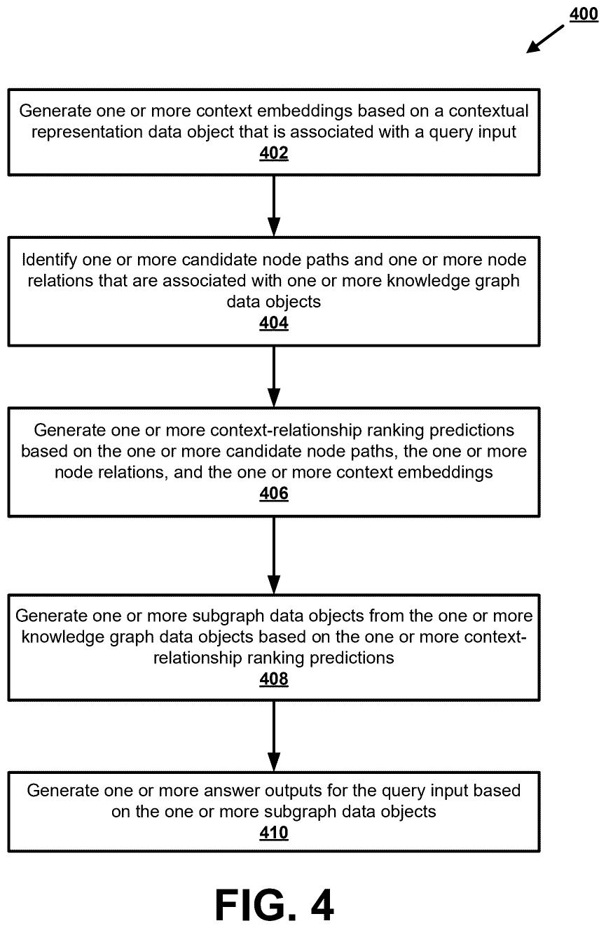

FIG. 4 is a flowchart diagram of an example process 400 for retrieving context relevant information in accordance with some embodiments of the present disclosure.

In some embodiments, the process 400 begins at step/operation 402 when the computing entity 200 generates one or more context embeddings based on a contextual representation data object that is associated with a query input. In some embodiments, a query input describes a request for information. For example, a query input may comprise one or more words, terms, or a string of characters, numbers, symbols, or any combination thereof, that may be entered by a user and received by a data analysis system from one or more client computing entities, either directly or indirectly via, e.g., an information retrieval system comprising a search engine. A query input may be used by an information retrieval system to match the query input with a corpus of content items or data objects for retrieval. According to various embodiments of the present disclosure, the query input may be received by computing system 101 and/or computing entity 200 from one or more client computing entity 102, either directly or indirectly via, e.g., an information retrieval system comprising a search engine.

In some embodiments, a context embedding describes a latent representation of a contextual representation data object. For example, a context embedding may be expressed as one or more vectors comprising one or more numbers representative of one or more data features or variables associated with a contextual representation data object. In some embodiments, a context embedding may be generated by mapping one or more data features of a contextual representation data object to one or more elements in a feature vector space. In some embodiments, one or more context embeddings comprises one or more multi-vector embeddings that are representative of a contextual representation data object of a query input. For example, one or more context embeddings of a query input may comprise one or more insights, such as intents and categories, for defining context ranges (or windows) of a given query. In some example embodiments, one or more context embeddings of a query input comprise a plurality of vectors—entities [procedure (e.g., MRI), problem (e.g., head pain), dependent (e.g., wife)], topics [“physician services”], categories [“preventive care”], and intent [“benefits”]).

In some embodiments, a contextual representation data object describes a context window comprising a range of contexts for a word or phrase, such as a query input. According to various embodiments of the present disclosure, a contextual representation data object of a query input comprises data that is representative of one or more entities, one or more topics, one or more categories, one or more intents, and one or more enriched utterances. For example, a contextual representation data object for a query input may comprise insights, such as entities (e.g., procedure: MRI, problem: head pain, dependent: wife), topics (e.g., “physician services”), categories (e.g., “preventative care”), and/or intent (e.g., “benefits”). In some embodiments, a context describes one or more features that are representative of a word or phrase, such as a query input.

In some embodiments, an entity describes a subject of a topic, such as an object (either real-world or virtual (e.g., data object or file)), location, article, person, program, service, task, operation, computing entity, and/or the like unit. According to various embodiments of the present disclosure, one or more entities are associated with one or more documents based on one or more document-topic-entity relationship features.

In some embodiments, a topic describes a subject matter or description that is representative of content associated with at least a portion of a document. According to various embodiments of the present disclosure, the contents of a document may be characterized by one or more topics. For example, a document may comprise one or more content portions and the one or more content portions may be associated with one or more topics. In some embodiments, a plurality of topics within a document may or may not be related. In some embodiments, one or more topics may be associated with one or more entities. In some embodiments, a topic is ranked based on a topic randomness score.

In some embodiments, a document describes an electronic file comprising content or information. A document may be stored in a database and indexed for retrieval, e.g., by a search engine. For example, a document may comprise content that matches a query input. The content of a document may comprise one or more segments that are associated with one or more topics, and the one or more topics may be associated with one or more entities. According to various embodiments of the present disclosure, a document may be ranked with respect to one or more topics and one or more entities based on one or more document-topic-entity relationship features.

In some embodiments, a document-topic-entity relationship feature describes a relationship between one or more documents, one or more topics, or one or more entities. According to various embodiments of the present disclosure, one or more document-topic-entity relationship features associated with a plurality of topics, a plurality of entities, and a plurality of documents are generated.

In some embodiments, a category describes a class to which an entity or topic may be assigned or associated with. A category may be used to describe a commonality among entities or topics within the category. For example, entities or topics may be assigned to or associated with specific categories based on data features of the entities or topics. That is, a category may be used to identify entities or topics comprising one or more shared data features.

In some embodiments, an intent describes a purpose or objective. For example, an intent of a query input may be identified and used to determine what a user that provided the query input wants to retrieve (e.g., one or more documents) or receive (e.g., an answer) in response to the query input.

In some embodiments, an enriched utterance describes one or more words, phrases, or string of text that comprise one or more enhancements to original one or more words, phrases, or string of text, such as a query input. An enriched utterance may be generated to improve a query input with respect to increasing relevancy, precision, or matching accuracy, e.g., via an information retrieval system, to a corpus of documents. In some embodiments, generating an enriched utterance comprises determining one or more of synonyms, spelling-corrections, or similar concepts with respect to a query input.

In some embodiments, generating one or more context embeddings comprises determining a plurality of positive constraints and/or negative constraints for a plurality of entities. A retrofitted entity may comprise an entity that is represented (e.g., as a node) in a knowledge graph data object and is enriched with positive constraints with respect to other entities, topics, or documents. A counter-fitted entity may comprise an entity that is represented (e.g., as a node) in a knowledge graph data object and is enriched with negative constraints with respect to other entities, topics, or documents.

In some embodiments, a plurality of positive constraints is determined for a plurality of retrofitted entities based on a cost function that is associated with a maximum distance measurement between a plurality of entities and a plurality of retrofitted entities. For example, given a set of entities E(e) and topics T(t) extracted from a query input q, which may represent a contextual window for identified documents D(d) that are linked to E(e) and T(t), a distance measurement may be used to define a cost function for retrofitted entities in a set of topics. As such, a positive (retrofitted) constraint

$${Z}_{r}^{cx}$$

may be determined by:

$${Z}_{r}^{cx} = {\sum }_{{e}^{′} ∈ {E}_{e}^{cw}}^{T} d ( {e}_{z} , {e}_{z}^{′} ) - ε \qquad Equation 1$$

where ε may be initialized with a value of zero (0) and represent a maximum distance between an entity e and a retrofitted entity e′. In some embodiments, the positive constraint cost function may be used to add weightage to context embeddings processed as a part of a query understanding module.

In some embodiments, given a set of retrofitted entities E′(e′) and topics T′(t′) for query q in a contextual window for identified documents D(d), a retrofitted entity is identified as a counter-fitted entity based on an absence of the retrofitted entity from documents d containing e and t. In some embodiments, a plurality of negative constraints for a plurality of counter-fitted entities is determined based on a cost function that is associated with a minimum distance measurement between a plurality of entities and a plurality of retrofitted entities. For example, a negative (counter-fitted) constraint

$${Z}_{c}^{cx}$$

may be determined by:

$${Z}_{c}^{cx} = {\sum }_{{e}^{′} ∈ {E}_{e}^{cw}}^{T} δ - d ( {e}_{z} , {e}_{z}^{′} ) \qquad Equation 2$$

where δ may be initialized with a value of one (1) and represent a minimum distance between entity e and retrofitted entity e′. In some embodiments, the negative constraint cost function may be used to add weightage to counter-fitted entities in context embeddings processed as a part of a query understanding module.

In some embodiments, generating one or more context embeddings comprises determining a plurality of similar contexts for a plurality of entities or topics based on one or more feature similarities. In some embodiments, a feature similarity describes a degree of likeness between a pair of features that are associated with a respective pair of entities or topics. In some embodiments, determining one or more feature similarities comprises (i) generating one or more retrofitted entities from a first portion of a plurality of entities or topics based on one or more inclusion features and (ii) generating one or more counter-fitted entities from a second portion of the plurality of entities or topics based on one or more exclusion features. In some embodiments, determining one or more feature similarities comprises (i) determining one or more hop relations based on a plurality of shared documents (e.g., entities or topics that appear in one or more of the same documents), (ii) associating a query input with one or more documents, one or more entities, or one or more topics based on the one or more hop relations, and (iii) generating one or more retrofitted entities or one or more counter-fitted entities based on the associations.

In some embodiments, generating one or more context embeddings comprises enhancing the one or more context embeddings by retrofitting similar contexts (e.g., using pre-trained models on WordNet) to align similar contexts or counter-fitting dissimilar contexts to disassociate dissimilar context. That is, one or more context embeddings comprising similar values may be retrofitted while one or more context embeddings comprising misfits may be counter-fitted. For example, similar contexts such as “physician office visit” and “preventive care” for given topic “physician services” may be associated based on services affinity, such as like “X-Ray,” “computed tomography (CT) scan,” or “magnetic resonance imaging (MRI)” while other services, such as “immunizations,” “mammography,” “colonoscopy,” “obesity” or other routing screenings may be segregated.

In some embodiments, at step/operation 404, the computing entity 200 identifies one or more candidate node paths and one or more node relations that are associated with one or more knowledge graph data objects.

In some embodiments, a node path describes a set of nodes that are connected by edges therebetween. According to various embodiments of the present disclosure, a node path is generated by traversing one or more neighboring nodes connected by one or more edges based on one or more node relations. In some embodiments, a node path is generated based on at least a portion of a knowledge graph data object. According to various embodiments of the present disclosure, one or more node paths are identified from one or more knowledge graph data objects. In some embodiments, a node path comprises a set of connected entity, topic, or documents nodes.

In some embodiments, a node relation describes a relationship of nodes (e.g., representative of entities, topics, or documents) in a graph, such as a knowledge graph data object. For example, a node relation between a pair of entities, topics, or documents may be determined based on (i) whether two nodes are connected by one or more edges and (ii) a number of edges or hops between the two nodes. According to various embodiments of the present disclosure, one or more node relations are identified from (e.g., edges of) one or more knowledge graph data objects.

In some embodiments, identifying one or more node relations comprises generating, using a variational autoencoder machine learning model, an output sequence of node relations based on an input sequence that comprises data from a knowledge graph data object, such as candidate node path including one or more candidate entities, one or more candidate topics, and one or more candidate node relations. For example, pₘ=(t₁e₁, r₁, t₁e₂, r₂ . . . rₘ₋₁, tₙeₘ) is representative of an input sequence pₘ of entities e, topics t, and relations r that comprises a candidate node path for a query qₘ.

In some embodiments, a variational autoencoder machine learning model describes parameters, hyperparameters, and/or defined operations of a machine learning model that is configured to generate a predictive output by reconstructing an input that is provided to the variational autoencoder machine learning model. A variational autoencoder machine learning model may provide capability for adapting to knowledge graph data objects that comprise evolving data or data that is not well defined (e.g., adapting edges and nodes that have not been seen/inducted before). In some embodiments, an input sequence that is provided to a variational autoencoder machine learning model comprises one or more embeddings of the data from the one or more knowledge graph data objects. In some embodiments, the input sequence is provided to a bidirectional recurrent neural network to generate the one or more embeddings.

In some embodiments, a knowledge graph data object describes a network of one or more data elements and one or more relationships between the one or more data elements. In some embodiments, the one or more data elements comprise nodes that are representative of topics, entities, or documents. For example, given sets of entities [E₁, E₂, E₃ . . . Eₙ] of a set of documents D and a set of topics [t₁, t₂, t₃ . . . tₙ] of a set of topics T, a knowledge graph data object G may comprise a set of vertices V that are associated with the entities, topics, and documents, and a set of edges Ed based on entity, topic, and document linkages (e.g., topic-entity-topic vertices, tᵢ↔eⱼ↔tₖ, where tᵢ, tₖ∈T, eⱼ∈E; and topic-document-topic vertices, tᵢ↔dⱼ↔tₖ, where tᵢ, tₖ∈T, dⱼ∈D).

According to various embodiments of the present disclosure, a knowledge graph data object comprises a representation of interrelationships between topics, entities, and documents. In some embodiments, a knowledge graph data object comprises (i) a plurality of nodes associated with one or more topics, one or more entities, or one or more documents and (ii) a plurality of edges between the plurality of nodes. In some embodiments, a knowledge graph data object is generated based on one or more document-topic-entity relationship features. In some embodiments, one or more answer outputs are generated based on one or more knowledge graph data objects (e.g., via one or more subgraph data objects).

In some embodiments, identifying one or more candidate node paths comprises generating one or more subgraph networks for one or more subgraph data objects. The following is an example algorithm for generating one or more subgraph networks:

```
  Input: Document D(d), Entities E(e), Topics T(t) where E, T ∈
  Initialization
  for topic t in T do
      for entity e in E do
        for eₙ in e neighbor in knowledge graph KG and eₙ ∉ E do
          if eₙ is related to entity e′ in E then
            Sample tokens t from e, e′
            Insert t into D after end of tokens sampling
            Insert eₙ to E
        end
end
    Insert E in T
  end
  Output: Document D′(d′), Entities E′(e′), Topics T′(t′).
```

In some embodiments, identifying one or more candidate node paths comprises generating one or more paths. The following is an example algorithm for generating one or more paths:

```
$E ( e ) ∈ retrofitted constraints {z}_{r}^{c x} , maximum hops = k$
Length of path z considering k hops
while length(p) ≤ z do
  if neighbor eᵢ of e_{z} related by relation label r from relation triplets Tᵣ
  Then
    contextual path p⁺ = p⁺ + (r, eᵢ)
    e_{z} = (e_{z} + eᵢ)
  else
    non − contextual path p⁻ = p⁻ + (r, eᵢ)
  length threshold Zₖ
  if length threhold = = k then
    break
end
Output: p⁺ & p⁻.
```

In some embodiments, at step/operation 406, the computing entity 200 generates one or more context-relationship ranking predictions based on the one or more candidate node paths, the one or more node relations, and the one or more context embeddings.

In some embodiments, a context-relationship ranking prediction describes a relevancy of a node path for a context (e.g., that is associated with a query input). A context-relationship ranking prediction may comprise a probability or score that is associated with a match or degree of similarity between a node path and a query input. In some embodiments, a context-relationship ranking prediction is used to assign a weight (e.g., positive (contextual path) or negative (non-contextual path)) to a node path (e.g., based on one or more knowledge graph data objects). According to various embodiments of the present disclosure, a context-relationship ranking prediction is generated based on (i) a candidate node path (e.g., from a plurality of node paths of a knowledge graph data object), (ii) one or more node relations associated with the candidate node path, and (iii) one or more context embeddings that are associated with a query input. In some embodiments, generating a context-relationship ranking prediction comprises (i) determining one or more context rankings that are associated with one or more context embeddings of a query input and (ii) determining one or more relationship rankings that are associated with one or more candidate node paths and one or more node relations of one or more knowledge graph data objects.

In some embodiments, a context-relationship ranking prediction comprises an output generated by a predictive machine learning model. In some embodiments, a predictive machine learning model describes parameters, hyperparameters, and/or defined operations of a machine learning model that is configured to generate one or more context-relationship ranking predictions based on one or more candidate node paths, one or more node relations, and one or more context embeddings. In some embodiments, a predictive machine learning model comprises a supervised machine learning model. In some embodiments, a predictive machine learning model is configured to generate one or more context-relationship ranking predictions by (i) comparing one or more knowledge graph embeddings that are associated with one or more nodes of one or more candidate node paths with one or more context embeddings that are associated with a query input and (ii) determining similarity between the one or more nodes and the one or more context embeddings based on the comparison. In some embodiments, the one or more knowledge graph embeddings are compared with one or more context embeddings with top Z context rankings. In some embodiments, the one or more knowledge graph embeddings are associated with one or more candidate node paths with top P relationship rankings.

In some embodiments, the predictive machine learning model is trained by generating one or more parameters based on training data that comprises a plurality of training queries, a plurality of training node paths, a plurality of training node relations, and a plurality of contextual path labels. In some example embodiments, the training data comprises a training embedding T_{E}=(Q(q), pₘ, Rᵣ, Ø_{qpr}), where Q(q) may represent a set of queries, pₘ may represent a set of training node paths for query qₘ, Rᵣ may represent a set of relations, and Ø_{qpr} may represent a similarity score between a training node path and ground truth.

In some embodiments, training data for training a predictive machine learning model may be generated by labeling, for a set of queries Q(q), one or more training node paths pₘ that comprise top k hops of connected nodes within one or more knowledge graph data objects. In some embodiments, one or more training node paths are labeled based on respective one or more classification outputs that are generated by a node path classifier machine learning model.

In some embodiments, a set of relations Rᵣ is determined by associated topics and subtopics in documents retrieved as a result of query qₘ.

In some embodiments, a similarity score describes a measure of how alike data objects are to each other. For example, a similarity score may be generated by comparing one or more first values of a first data construct with one or more first values of a second data construct. In some embodiments, a similarity score is determined based on a distance function. A distance function may comprise a mathematical formula that may be used to calculate a distance between features of two data objects. Examples of distance functions include, but are not limited to, Euclidean distance, Manhattan distance, Minkowski distance, Jaccard distance, Cosine similarity, and any other types of distance measurements apparent to one of ordinary skill in the art.

In some embodiments, a node path classifier machine learning model is used or configured to label one or more training node paths by generating weights for node paths within one or more knowledge graph data objects thereby creating labeled contextual paths as training node paths. In some embodiments, a node path classifier machine learning model comprises a binary classifier machine learning model. In some embodiments, a plurality of node paths contributes to a labeled contextual path in a manner where node path weights are agnostic to path length (despite a longer path may indeed be most relevant path for a context). In some embodiments, a node path classifier machine learning model is trained on node paths that are labeled as either positive contextual paths or negative non-contextual paths. In some embodiments, a node path classifier machine learning model is trained based on a set of data triples {qₘ, pₖ, y_{m,k}}, where qₘ=(topic, head_{entity}, tail_{entity}, documents) and represents a query, pₖ denotes a training node path, and y_{m,k} denotes a labeled context as positive or negative (p⁺, p⁻). According to various embodiments of the present disclosure, a node path classifier machine learning model (i) generates predicted node path scores, (ii) compares the predicted node path scores with actual node path scores, and (iii) learns to minimize a difference between the predicted node path score and the actual node path scores.

In some embodiments, training data for training a predictive machine learning model comprises a training dataset and a validation dataset. In some embodiments, a predictive machine learning model is trained on a training dataset and fine-tuned on a validation dataset. According to various embodiments of the present disclosure, a predictive machine learning mode is fine-tuned by (i) generating one or more validation context-relationship ranking predictions for one or more validation node paths based on one or more trained parameters, (ii) generating one or more similarity scores by comparing the one or more validation context-relationship ranking predictions with respective one or more actual rankings for the one or more validation node paths, and (iii) fine-tuning the predictive machine learning model by generating one or more updated parameters based on the one or more similarity scores.

In some embodiments, at step/operation 408, the computing entity 200 generates one or more subgraph data objects from the one or more knowledge graph data objects based on the one or more context-relationship ranking predictions.

In some embodiments, a subgraph data object describes a network of one or more data elements (e.g., nodes and edges associated with topics, entities, or documents) and one or more relationships between the one or more data elements. According to various embodiments of the present disclosure, one or more subgraph data objects are generated from one or more knowledge graph data objects (e.g., via one or more node paths and one or more node relations) based on one or more context-relationship ranking predictions. That is, a subgraph data object may be representative of specific data (e.g., node paths and node relations) identified and/or extracted from one or more knowledge graph data objects. In some embodiments, a subgraph data object (e.g., for generating answer outputs) is generated by determining one or more documents and/or entities that are high ranking with respect to a query input based on one or more knowledge graph data objects and/or a knowledge base comprising one or more document-topic-entity relationship features and rankings associated with the one or more documents and/or entities. In some embodiments, one or more answer outputs are generated for a query input based on one or more subgraph data objects.

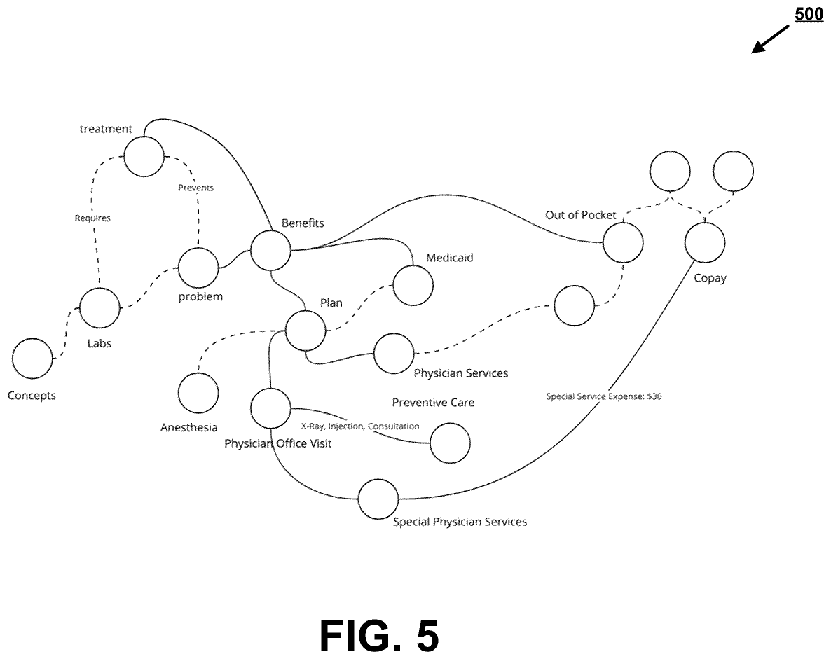

FIG. 5 depicts an operational example of a subgraph data object 500 in accordance with some embodiments of the present disclosure. As depicted in FIG. 5, a subgraph data object 500 may include a plurality of nodes that are representative of topics, entities, and/or documents. One or more of the plurality of nodes may be connected via one or more edges that are representative of one or more relationships between the nodes. In the depicted example, edges with dashed lines may indicate negative weightings (e.g., negative constraints between counter-fitted entities) and solid lines may indicate positive weightings (e.g., positive constraints between retrofitted entities). The operational example of FIG. 5 uses a clinical domain as one example.

Returning to FIG. 4, in some embodiments, at step/operation 410, the computing entity 200 generates one or more answer outputs for the query input based on the one or more subgraph data objects.

In some embodiments, an answer output describes a response to a query input. For example, an answer output may comprise any one of information, predictions, or content items (e.g., provided as search results). According to various embodiments of the present disclosure, one or more answer outputs are generated based on one or more subgraph data objects. In some embodiments, generating the one or more answer outputs comprises traversing the one or more subgraph data objects and identifying one or more entities and/or one or more documents from the one or more subgraph data objects that are relevant to a query input based on the traversal of the one or more subgraph data objects.

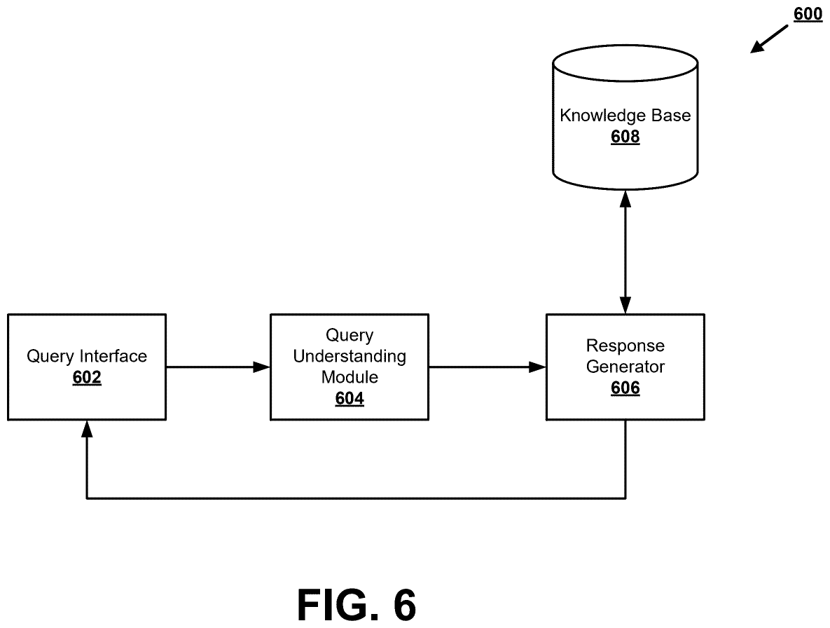

FIG. 6 depicts an operational example of an information retrieval system 600 in accordance with some embodiments of the present disclosure. As depicted in FIG. 6, information retrieval system 600 comprises a query interface 602, a query understanding module 604, a response generator 606, and a knowledge base 608 that may individually and/or collectively comprise predictive data analysis computing entity 106 and one or more external computing entities 108.

In some embodiments, query interface 602 is configured to receive one or more query inputs from, for example, client computing entity 102 and provide the one or more query inputs to the query understanding module 604. In some embodiments, the query understanding module 604 is configured to extract insights from the one or more query inputs. Examples of insights include, but are not limited to, entities, topics, categories, or intents. In some embodiments, contextual representation data objects are generated based on the insights and provided to the response generator 606.

In some embodiments, the response generator 606 is configured to retrieve information that is responsive to the one or more query inputs from knowledge base 608 based on contextual representation data objects received from the query understanding module 604. In some embodiments, the response generator 606 comprises a search engine. In some embodiments, the response generator 606 is configured to retrieve information from the knowledge base 608 by (i) generating one or more context embeddings based on a contextual representation data object that is associated with a query input, (ii) identifying one or more candidate node paths and one or more node relations that are associated with one or more knowledge graph data objects, (iii) generating, using a predictive machine learning model, one or more context-relationship ranking predictions based on the one or more candidate node paths, the one or more node relations, and the one or more context embeddings, (iv) generating one or more subgraph data objects from the one or more knowledge graph data objects based on the one or more context-relationship ranking predictions, and (v) generating one or more answer outputs for the query input based on the one or more subgraph data objects. In some embodiments, the one or more answer outputs are provided to the query interface 602 responsive to respective one or more query inputs.

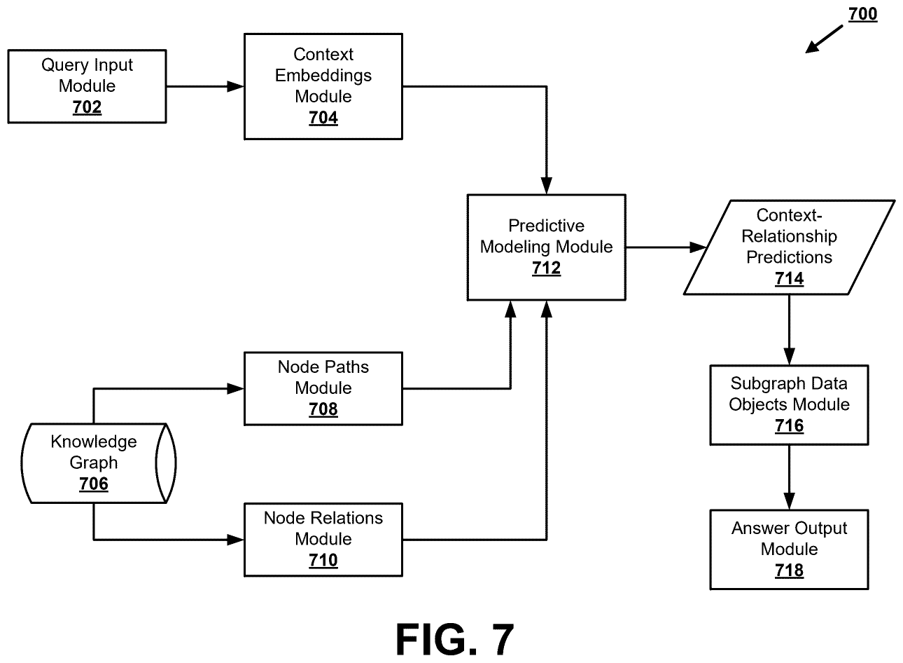

FIG. 7 depicts an example architecture of a predictive information retrieval framework 700 in accordance with some embodiments of the present disclosure. As depicted in FIG. 7, the predictive information retrieval framework 700 comprises a predictive modeling module 712 that receives (i) context embeddings from context embeddings module 704, (ii) candidate node paths from node paths module 708, and (iii) node relations from node relations module 710. In some embodiments, context embeddings module 704 generates context embeddings based on query inputs from query input module 702. Node paths module 708 and node relations module 710 may generate candidate node paths and node relations, respectively, based on data from knowledge graph 706.

As further depicted in FIG. 7, predictive modeling module 712 generates context-relationship predictions 714. In some embodiments, the predictive modeling module 712 may use a predictive machine learning model to generate the context-relationship predictions 714 based on context embeddings, candidate node paths, and node relations generated by the context embeddings module 704, the node paths module 708, and the node relations module 710, respectively.

In some embodiments, the predictive modeling module 712 further determines (i) context rankings based on context embeddings generated by the context embeddings module 704 and (ii) relationship rankings based on (a) candidate node paths generated by the node paths module 708 and (b) node relations generated by the node relations module 710. In some embodiments, the context-relationship predictions 714 are generated by the predictive modeling module 712 based on context rankings and relationship rankings. Subgraph data objects module 716 may use the context-relationship predictions 714 to generate subgraph data objects. Subgraph data objects generated by subgraph data objects module 716 may be used by answer output module 718 to generate answer outputs that are responsive to query inputs from query input module 702.

Accordingly, as described above, various embodiments of the present disclosure make important technical contributions to contextual text analysis that address the efficiency and reliability shortcomings of existing information retrieval systems. To do so, the predictive machine learning models may be trained to generate context-relationship ranking predictions based on candidate node paths, node relations, and context embeddings. As such, information associated with relationships and rankings of a plurality of topics, entities, and documents may be extracted from query inputs and leveraged to generate answer outputs that are targeted based on contexts and dependencies. By doing so, some of the techniques of the present disclosure improve the training speed and training efficiency of training predictive machine learning models while improving the predictive performance of the resulting models.

Accordingly, techniques that improve predictive accuracy without harming training speed, such as the techniques described herein, enable improving training speed given a constant predictive accuracy. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training machine learning models.

Some techniques of the present disclosure enable the generation of subgraphs that may be used to generate responses to query inputs. The techniques of the present disclosure may be used, applied, and/or otherwise leveraged to generate context-relationship ranking predictions based on contextual representation data that is associated with query inputs, which may help in the computer interpretation of relationships between topics, entities, and documents. The predictive machine learning model of the present disclosure may be leveraged to generate responses to search queries that improve the performance of a computing system (e.g., a computer itself, etc.) with respect to various predictive actions performed by the computing entity 200, such as for the generating of context-relationship ranking predictions and the generating of answer outputs based on the context-relationship ranking predictions via subgraph data objects, and/or the like.

In some examples, the answer outputs may include predictive actions that may be based on a prediction domain. A prediction domain may include any environment in which computing systems may be applied to achieve real-word insights, such as predictions (e.g., entity-document relationships), and initiate the performance of computing tasks, such as prediction actions to act on the real-world insights. These predictive actions may cause real-world changes, for example, by controlling a hardware component, providing alerts, interactive actions, and/or the like.

Examples of prediction domains may include financial systems, clinical systems, autonomous systems, robotic systems, and/or the like. Predictive actions in such domains may include the initiation of automated instructions across and between devices, automated notifications, automated scheduling operations, automated precautionary actions, automated security actions, automated data processing actions, automated data compliance actions, automated data access enforcement actions, automated adjustments to computing and/or human data access management, and/or the like.

### VI. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising: generating, by one or more processors, one or more context embeddings based on a contextual representation data object that is associated with a query input; identifying, by the one or more processors, one or more candidate node paths and one or more node relations that are associated with one or more knowledge graph data objects; generating, by the one or more processors and using a predictive machine learning model, one or more context-relationship ranking predictions based on the one or more candidate node paths, the one or more node relations, and the one or more context embeddings; generating, by the one or more processors, one or more subgraph data objects from the one or more knowledge graph data objects based on the one or more context-relationship ranking predictions; and generating, by the one or more processors, one or more answer outputs for the query input based on the one or more subgraph data objects.

Example 2. The computer-implemented method of example 1, wherein generating the one or more context embeddings further comprises determining a plurality of similar contexts for a plurality of entities or topics based on one or more feature similarities.

Example 3. The computer-implemented method of example 2 further comprising determining the one or more feature similarities by: generating one or more retrofitted entities from a first portion of the plurality of entities or topics based on one or more inclusion features; and generating one or more counter-fitted entities from a second portion of the plurality of entities or topics based on one or more exclusion features.

Example 4. The computer-implemented method of example 2 further comprising determining the one or more feature similarities by: determining one or more hop relations based on a plurality of shared documents; associating the query input with one or more documents, one or more entities, or one or more topics based on the one or more hop relations; and generating one or more retrofitted entities or one or more counter-fitted entities based on the associations.

Example 5. The computer-implemented method of any of examples 1 through 4, wherein generating the one or more context embeddings further comprises determining a plurality of positive constraints for a plurality of entities based on a cost function that is associated with a maximum distance measurement between the plurality of entities and a plurality of retrofitted entities.

Example 6. The computer-implemented method of any of examples 1 through 5, wherein generating the one or more context embeddings further comprises determining a plurality of negative constraints for a plurality of counter-fitted entities based on a cost function that is associated with a minimum distance measurement between the plurality of entities and a plurality of retrofitted entities.

Example 7. The computer-implemented method of any of examples 1 through 6, wherein the predictive machine learning model comprises a supervised machine learning model.

Example 8. The computer-implemented method of any of examples 1 through 7, wherein the predictive machine learning model is configured to generate the one or more context-relationship ranking predictions by: comparing one or more knowledge graph embeddings that are associated with one or more nodes of the one or more candidate node paths with the one or more context embeddings; and determining similarity between the one or more nodes and the one or more context embeddings based on the comparison.

Example 9. The computer-implemented method of examples 1 through 8 further comprising training the predictive machine learning model by generating one or more parameters based on training data that comprises a plurality of training queries, a plurality of training node paths, a plurality of training node relations, and a plurality of contextual path labels.

Example 10. The computer-implemented method of example 9 further comprising training the predictive machine learning model by: generating one or more validation context-relationship ranking predictions for one or more validation node paths based on the one or more parameters; generating one or more similarity scores by comparing the one or more validation context-relationship ranking predictions with respective one or more actual rankings for the one or more validation node paths; and fine-tuning the predictive machine learning model by generating one or more updated parameters based on the one or more similarity scores.

Example 11. The computer-implemented method of examples 1 through 10, wherein identifying the one or more node relations comprises generating, using a variational autoencoder machine learning model, an output sequence of node relations based on an input sequence that comprises one or more candidate entities, one or more candidate topics, and one or more candidate node relations that are associated with the one or more knowledge graph data objects.

Example 12. The computer-implemented method of example 11 further comprising generating, using a bidirectional recurrent neural network, one or more embeddings of the one or more knowledge graph data objects based on the input sequence.

Example 13. The computer-implemented method of examples 1 through 12, wherein the one or more knowledge graph data objects comprise (i) a plurality of nodes associated with a plurality of topics, a plurality of entities, or a plurality of documents and (ii) a plurality of edges between the plurality of nodes.

Example 14. A computing system comprising memory and one or more processors communicatively coupled to the memory, the one or more processors configured to: generate one or more context embeddings based on a contextual representation data object that is associated with a query input; identify one or more candidate node paths and one or more node relations that are associated with one or more knowledge graph data objects; generate, using a predictive machine learning model, one or more context-relationship ranking predictions based on the one or more candidate node paths, the one or more node relations, and the one or more context embeddings; generate one or more subgraph data objects from the one or more knowledge graph data objects based on the one or more context-relationship ranking predictions; and generate one or more answer outputs for the query input based on the one or more subgraph data objects.

Example 15. The computing system of example 14, wherein the one or more processors are further configured to generate the one or more context embeddings by determining a plurality of positive constraints for a plurality of entities based on a cost function that is associated with a maximum distance measurement between the plurality of entities and a plurality of retrofitted entities.

Example 16. The computing system of example 14, wherein the one or more processors are further configured to generate the one or more context embeddings by determining a plurality of negative constraints for a plurality of counter-fitted entities based on a cost function that is associated with a minimum distance measurement between the plurality of entities and a plurality of retrofitted entities.

Example 17. The computing system of example 14, wherein the predictive machine learning model is configured to generate the one or more context-relationship ranking predictions by: comparing one or more knowledge graph embeddings that are associated with one or more nodes of the one or more candidate node paths with the one or more context embeddings; and determining similarity between the one or more nodes and the one or more context embeddings based on the comparison.

Example 18. The computing system of example 14, wherein the one or more processors are further configured to train the predictive machine learning model by generating one or more parameters based on training data that comprises a plurality of training queries, a plurality of training node paths, a plurality of training node relations, and a plurality of contextual path labels.

Example 19. The computing system of example 18, wherein the one or more processors are further configured to train the predictive machine learning model by: generating one or more validation context-relationship ranking predictions for one or more validation node paths based on the one or more parameters; generating one or more similarity scores by comparing the one or more validation context-relationship ranking predictions with respective one or more actual rankings for the one or more validation node paths; and fine-tuning the predictive machine learning model by generating one or more updated parameters based on the one or more similarity scores.

Example 20. One or more non-transitory computer-readable storage media including instructions that, when executed by one or more processors, cause the one or more processors to: generate one or more context embeddings based on a contextual representation data object that is associated with a query input; identify one or more candidate node paths and one or more node relations that are associated with one or more knowledge graph data objects; generate, using a predictive machine learning model, one or more context-relationship ranking predictions based on the one or more candidate node paths, the one or more node relations, and the one or more context embeddings; generate one or more subgraph data objects from the one or more knowledge graph data objects based on the one or more context-relationship ranking predictions; and generate one or more answer outputs for the query input based on the one or more subgraph data objects.

Example 21. The computer-implemented method of example 1, wherein the predictive machine learning model comprises a supervised machine learning model and the method further comprises training the supervised machine learning model to generate the one or more context-relationship ranking predictions by minimizing a difference between one or more validation context-relationship ranking predictions and respective one or more actual rankings that are associated with one or more validation node paths.

Example 22. The computer-implemented method of example 21, wherein the training is performed by the one or more processors.

Example 23. The computer-implemented method of example 21, wherein the one or more processors are included in a first computing entity; and the training is performed by one or more other processors included in a second computing entity.

Example 24. The computer-implemented method of example 1, wherein the one or more processors are included in a first computing entity; and the generating of the one or more context-relationship ranking predictions is performed by one or more other processors included in a second computing entity.

Example 25. The computing system of example 14, wherein the predictive machine learning model comprises a supervised machine learning model and the one or more processors are further configured to train the supervised machine learning model to generate the one or more context-relationship ranking predictions by minimizing a difference between one or more validation context-relationship ranking predictions and respective one or more actual rankings that are associated with one or more validation node paths.

Example 26. The computing system of example 25, wherein the training is performed by the one or more processors.

Example 27. The computing system of example 25, wherein the one or more processors are included in a first computing entity; and the training is performed by one or more other processors included in a second computing entity.

Example 28. The computing system of example 14, wherein the one or more processors are included in a first computing entity; and the generating of the one or more context-relationship ranking predictions is performed by one or more other processors included in a second computing entity.

Example 29. The one or more non-transitory computer-readable storage media of example 14, wherein the predictive machine learning model comprises a supervised machine learning model and the one or more non-transitory computer-readable storage media further comprises instructions that, when executed by the one or more processors, cause the one or more processors to train the supervised machine learning model to generate the one or more context-relationship ranking predictions by minimizing a difference between one or more validation context-relationship ranking predictions and respective one or more actual rankings that are associated with one or more validation node paths.

Example 30. The one or more non-transitory computer-readable storage media of example 29, wherein the training is performed by the one or more processors.

Example 31. The one or more non-transitory computer-readable storage media of example 29, wherein the one or more processors are included in a first computing entity; and the training is performed by one or more other processors included in a second computing entity.

Example 32. The one or more non-transitory computer-readable storage media of example 18, wherein the one or more processors are included in a first computing entity; and the generating of the one or more context-relationship ranking predictions is performed by one or more other processors included in a second computing entity.

1. A computer-implemented method comprising:
generating, by one or more processors, one or more context embeddings based on a contextual representation data object that is associated with a query input;
identifying, by the one or more processors, one or more candidate node paths and one or more node relations that are associated with one or more knowledge graph data objects;
generating, by the one or more processors and using a predictive machine learning model, one or more context-relationship ranking predictions based on the one or more candidate node paths, the one or more node relations, and the one or more context embeddings;
generating, by the one or more processors, one or more subgraph data objects from the one or more knowledge graph data objects based on the one or more context-relationship ranking predictions; and
generating, by the one or more processors, one or more answer outputs for the query input based on the one or more subgraph data objects.

2. The computer-implemented method of claim 1, wherein generating the one or more context embeddings further comprises determining a plurality of similar contexts for a plurality of entities or topics based on one or more feature similarities.

3. The computer-implemented method of claim 2 further comprising determining the one or more feature similarities by:
generating one or more retrofitted entities from a first portion of the plurality of entities or topics based on one or more inclusion features; and
generating one or more counter-fitted entities from a second portion of the plurality of entities or topics based on one or more exclusion features.

4. The computer-implemented method of claim 2 further comprising determining the one or more feature similarities by:
determining one or more hop relations based on a plurality of shared documents;
associating the query input with one or more documents, one or more entities, or one or more topics based on the one or more hop relations; and
generating one or more retrofitted entities or one or more counter-fitted entities based on the associations.

5. The computer-implemented method of claim 1, wherein generating the one or more context embeddings further comprises determining a plurality of positive constraints for a plurality of entities based on a cost function that is associated with a maximum distance measurement between the plurality of entities and a plurality of retrofitted entities.

6. The computer-implemented method of claim 1, wherein generating the one or more context embeddings further comprises determining a plurality of negative constraints for a plurality of counter-fitted entities based on a cost function that is associated with a minimum distance measurement between the plurality of entities and a plurality of retrofitted entities.

7. The computer-implemented method of claim 1, wherein the predictive machine learning model comprises a supervised machine learning model.

8. The computer-implemented method of claim 1, wherein the predictive machine learning model is configured to generate the one or more context-relationship ranking predictions by:
comparing one or more knowledge graph embeddings that are associated with one or more nodes of the one or more candidate node paths with the one or more context embeddings; and
determining similarity between the one or more nodes and the one or more context embeddings based on the comparison.

9. The computer-implemented method of claim 1 further comprising training the predictive machine learning model by generating one or more parameters based on training data that comprises a plurality of training queries, a plurality of training node paths, a plurality of training node relations, and a plurality of contextual path labels.

10. The computer-implemented method of claim 9 further comprising training the predictive machine learning model by:
generating one or more validation context-relationship ranking predictions for one or more validation node paths based on the one or more parameters;
generating one or more similarity scores by comparing the one or more validation context-relationship ranking predictions with respective one or more actual rankings for the one or more validation node paths; and
fine-tuning the predictive machine learning model by generating one or more updated parameters based on the one or more similarity scores.

11. The computer-implemented method of claim 1, wherein identifying the one or more node relations comprises generating, using a variational autoencoder machine learning model, an output sequence of node relations based on an input sequence that comprises one or more candidate entities, one or more candidate topics, and one or more candidate node relations that are associated with the one or more knowledge graph data objects.

12. The computer-implemented method of claim 11 further comprising generating, using a bidirectional recurrent neural network, one or more embeddings of the one or more knowledge graph data objects based on the input sequence.

13. The computer-implemented method of claim 1, wherein the one or more knowledge graph data objects comprise (i) a plurality of nodes associated with a plurality of topics, a plurality of entities, or a plurality of documents and (ii) a plurality of edges between the plurality of nodes.

14. A computing system comprising memory and one or more processors communicatively coupled to the memory, the one or more processors configured to:
generate one or more context embeddings based on a contextual representation data object that is associated with a query input;
identify one or more candidate node paths and one or more node relations that are associated with one or more knowledge graph data objects;
generate, using a predictive machine learning model, one or more context-relationship ranking predictions based on the one or more candidate node paths, the one or more node relations, and the one or more context embeddings;
generate one or more subgraph data objects from the one or more knowledge graph data objects based on the one or more context-relationship ranking predictions; and
generate one or more answer outputs for the query input based on the one or more subgraph data objects.

15. The computing system of claim 14, wherein the one or more processors are further configured to generate the one or more context embeddings by determining a plurality of positive constraints for a plurality of entities based on a cost function that is associated with a maximum distance measurement between the plurality of entities and a plurality of retrofitted entities.

16. The computing system of claim 14, wherein the one or more processors are further configured to generate the one or more context embeddings by determining a plurality of negative constraints for a plurality of counter-fitted entities based on a cost function that is associated with a minimum distance measurement between the plurality of entities and a plurality of retrofitted entities.

17. The computing system of claim 14, wherein the predictive machine learning model is configured to generate the one or more context-relationship ranking predictions by:
comparing one or more knowledge graph embeddings that are associated with one or more nodes of the one or more candidate node paths with the one or more context embeddings; and
determining similarity between the one or more nodes and the one or more context embeddings based on the comparison.

18. The computing system of claim 14, wherein the one or more processors are further configured to train the predictive machine learning model by generating one or more parameters based on training data that comprises a plurality of training queries, a plurality of training node paths, a plurality of training node relations, and a plurality of contextual path labels.

19. The computing system of claim 18, wherein the one or more processors are further configured to train the predictive machine learning model by:
generating one or more validation context-relationship ranking predictions for one or more validation node paths based on the one or more parameters;
generating one or more similarity scores by comparing the one or more validation context-relationship ranking predictions with respective one or more actual rankings for the one or more validation node paths; and
fine-tuning the predictive machine learning model by generating one or more updated parameters based on the one or more similarity scores.

20. One or more non-transitory computer-readable storage media including instructions that, when executed by one or more processors, cause the one or more processors to:
generate one or more context embeddings based on a contextual representation data object that is associated with a query input;
identify one or more candidate node paths and one or more node relations that are associated with one or more knowledge graph data objects;
generate, using a predictive machine learning model, one or more context-relationship ranking predictions based on the one or more candidate node paths, the one or more node relations, and the one or more context embeddings;
generate one or more subgraph data objects from the one or more knowledge graph data objects based on the one or more context-relationship ranking predictions; and
generate one or more answer outputs for the query input based on the one or more subgraph data objects.
